(19) United States
(12) Patent Application Publication
(10) Pub. No.: US 2008/0195758 A1
(43) Pub. Date: Aug. 14, 2008

(54) Method and Server System for Transferring an Object to a Wireless Device from a Predetermined Web Page

(76) Inventors: Rao Nageswara, Mumbai (IN); Attray Hemant, Mumbai (IN); Jha Krishna, Mumbai (IN)

Correspondence Address: GLOBAL IP SERVICES, PLLC, 10 CRESTWOOD LANE, NASHUA, NH, 03062, US

(21) Appl. No.: 11/914,452

(22) PCT Filed: Sep. 13, 2005
(86) PCT No.: PCT/IN05/00309

§ 371 Date: Nov. 15, 2007

(30) Foreign Application Priority Data
Jun. 30, 2005 (IN) 772/MUM/2005

(51) Int. Cl. G06F 15/16

(52) U.S. Cl. 709/246

(57) ABSTRACT

A method and system for transferring an object to a wireless device is provided. The method includes converting the format of the object to a wireless-device-format in response to a user input. The object is embedded in a predetermined web page and the wireless-device-format is a corresponding format supported by the wireless device. The method further includes sending the object in the wireless-device-format to the wireless device.

### BACKGROUND

The present invention generally relates to e-commerce. More specifically, the present invention relates to a method and server system for transferring an object from a predetermined web page to a wireless device.

In existing systems, there are specific web pages that enable transfer of predefined objects to a wireless device. These specific web pages have a repository of a plurality of predetermined wireless-device-formats supported by different wireless devices of each predefined object. In response to a user input for transfer of a predefined object, a predetermined wireless-device-format of the predefined object, corresponding to the user input, is retrieved from the repository and is transferred to the wireless device of the user. The user is then billed through either the operator of the wireless device or credit card of the user. However, other objects that do not have corresponding predetermined wireless-device-formats in the repository cannot be transferred to the wireless device.

There is therefore a need of a method and system that enables transfer of these other objects to the wireless device. Further, there is a need of a method and system that eliminates the requirement of maintaining a repository of a plurality of predetermined wireless-device-formats (supported by different wireless devices) of each object that can be transferred to the wireless device.

### SUMMARY

An object of the present invention is to provide a method and system for transferring an object from a predetermined web page to a wireless device.

Another object of the present invention is to provide a method for monetizing an object, which is embedded on a predetermined web page.

In order to fulfill the above-mentioned objects, a method for transferring an object to a wireless device is provided. The method includes converting the format of the object to a wireless-device-format in response to a user input. The object is embedded in a predetermined web page and the wireless-device-format is a corresponding format supported by the wireless device. The method further includes sending the object in the wireless-device-format to the wireless device.

### BRIEF DESCRIPTION OF THE DRAWINGS

A more complete appreciation of the present invention and the attended advantages will become readily apparent as the same becomes better understood by reference of the following detailed description when considered in conjunction with the accompanying drawings in which reference symbols indicate the same or similar components, wherein:

FIG. 1 is a flowchart of a method for transferring an object to a wireless device, in accordance with an embodiment of the present invention.

FIG. 2 is a flowchart of a method for sending an object to the wireless device, in accordance with an embodiment of the present invention.

FIG. 3 is a flowchart for monetizing an object, in accordance with an embodiment of the present invention.

FIG. 4 is a block diagram of a server system, in accordance with an embodiment of the present invention.

### DETAILED DESCRIPTION OF DRAWINGS

The present invention provides a method and system for transferring an object from a predetermined web page to a wireless device. Examples of the object for transferring from the predetermined web page to a wireless device are image file, text files, video files and the like.

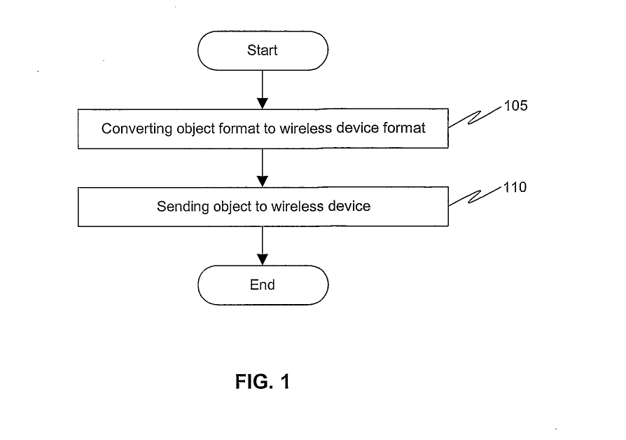

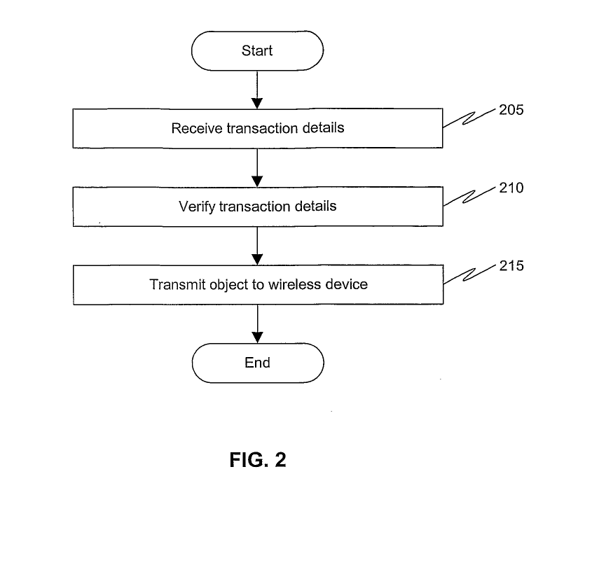

FIG. 1 is a flowchart of a method for transferring an object to a wireless device, in accordance with an embodiment of the present invention. At step 105, the format of the object is converted to a wireless-device-format in response to a user input. A wireless-device-format is supported by the wireless device and displays the object on the wireless device in an identical manner as the object is displayed on the predetermined web page. Examples of the wireless-device-format are image, text, 3GP (Third Generation Phone) video, MIDI (Musical Instrument Digital Interface) file and the like. An example of the user input for transferring the object to the wireless device is clicking on the link available for the object on the predetermined web page. Example of wireless device is mobile phone and Personal Digital Assistant (PDA). In accordance with an embodiment of the present invention, the object is converted to the wireless-device-format at runtime in response to the user input. The object may also be edited based on the user input. An example of the user input for editing the object may be selecting a part of the overall object, rotating the object, flipping the object, zooming-in or zooming-out the object. In an embodiment of the present invention, the format of the object is converted to a wireless-device-format selected by the user. At step 110, the object is sent to the wireless device in the wireless-device-format. This is further explained in conjunction with FIG. 2.

FIG. 2 is a flowchart of a method for sending an object to the wireless device, in accordance with an embodiment of the present invention. At step 205, transaction details from the user are received. The transaction details may be identification details of the wireless device, details of the wireless operator, credit card details and/or the like.

At step 210, received transaction details are verified. In an example, if the user selects payment for the transfer via a credit card, the credit card bank system is invoked and the details of the credit card received from the user are verified. In another example, if the user selects the billing through the operator of the wireless device, a code is provided with a message to the user and the user is requested to return enter the code for verification.

At step 215, object is then transmitted to the wireless device in the wireless-device-format. In an embodiment of the present invention, transfer details are also provided to the user. The transfer details may be the details of the object, the model of the wireless device and the price of transferring the object for confirmation before the transfer of the object to the wireless device. The object may be transmitted to the wireless device using Short Message Service (SMS), Wireless Application Protocol (WAP), General Packet Radio Service (GPRS) or the like. In an exemplary embodiment of the present invention, if the user chooses not transfer the object instantly, a link is sent to the wireless device with details and steps of transferring the object using the link.

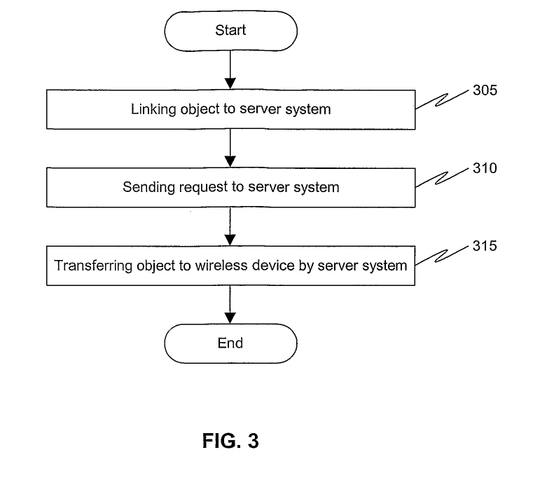

FIG. 3 is a flowchart of a method for monetizing an object, in accordance with an embodiment of the present invention. At step 305, the object is linked to a server system so as to integrate the predetermined web page with the server system.

In an embodiment of the present invention, the predetermined web page is manually integrated to the server system. The administrator of the predetermined web page changes the source code of the predetermined web page to link an object to the server system. In an exemplary embodiment of the present invention, stock integration is performed to integrate the predetermined web page to the server system. In stock integration, objects of the predetermined web page that can be transferred to the wireless device are displayed as icons at a specified location of the predetermined web page. In another exemplary embodiment of the present invention, item integration is performed to integrate the predetermined web page to the server system. In item integration, an object that can be transferred to the wireless device is provided a direct link or an indirect link to the sever system.

In another embodiment of the present invention, the predetermined web page is automatically integrated to the server system. The object is identified and tagged to the server system. In an exemplary embodiment of the present invention, the following script is added in the source code of the predetermined web page:

<script>
embed method=”stock”
</script>
<script type=”text/javascript” src=’hyerplink of the server system”>
</script>

At step 310, a request is sent to the server system to transfer the object in response to the user input. The transaction details are verified by the server system. The object in the wireless-device-format is transmitted to the wireless device after the verification of the transaction details. The server system may also edit the object based on the user input. At step 315, the object is transferred to the wireless device in response to receiving the request. The object format is converted to the wireless-device-format. The object is then sent to the wireless device in the wireless device format. The method of sending an object to the wireless device is explained in conjunction with FIG. 2.

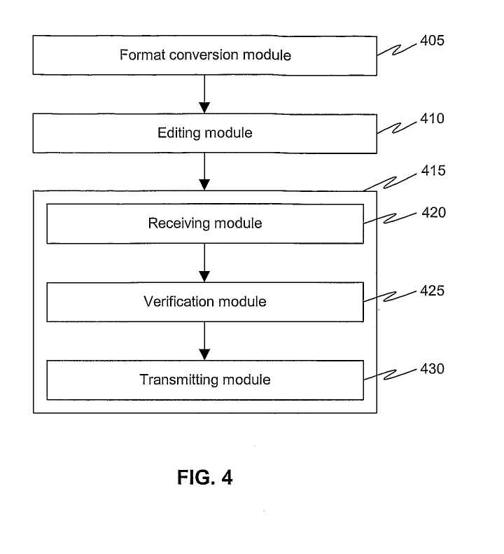

FIG. 4 is a block diagram for a server system 400, in accordance with another embodiment of the present invention. Server system 400 transfers an object to a wireless device in response to a user input. The object is linked to server system 400. Server system 400 comprises a format-conversion module 405, an editing module 410 and an object-sending module 415. Object-sending module 415 comprises a receiving module 420, a verification module 425 and a transmitting module 430.

Format-conversion module 405 converts the format of the object to the wireless-device-format. The object is linked to the server system by integrating the web page and the server system.

Editing module 410 edits the object according to the user input. The user may select a part of the overall object and rotate the object, flip the object, zoom-in and zoom-out the object before transferring the object to the wireless device. Also, if the object is a sound or video object, the user may select to edit the duration and/or frames for the object.

Object-sending module 415 sends the object in the wireless-device-format to the wireless device. Object-sending module comprises receiving module 420, verification module 425 and transmitting module 430. Receiving module 420 receives the transaction details from the user. Verification module 425 verifies the received transaction details. Transmitting module 430 transmits the object in the wireless-device-format. In an embodiment of the present invention, transmitting module 430 provides transfer details to the user. The transfer details may be the details of the object, the model of the wireless device and the price of transferring the object for confirmation before the transfer of the object to the wireless device. The object may be transmitted to the wireless device using Short Message Service (SMS), Wireless Application Protocol (WAP), General Packet Radio Service (GPRS) or the like. In an exemplary embodiment of the present invention, if the user chooses not to transfer the object instantly, a link is sent to the wireless device with details and steps of transferring the object using the link.

In an embodiment of the present invention, format-conversion module 405 and object-sending module 415 can be integrated into a single module.

The various embodiments of the present invention provide a method and server system for transferring an object to a wireless device from a predetermined web page which otherwise is not available for transfer. Therefore, the requirement of maintaining a repository of a plurality of wireless-device-formats (supported by different wireless devices) of each object that can be transferred to the wireless device is eliminated.

Further, the various embodiments of the present invention provide a method for monetizing an object, which is embedded on a predetermined web page. As a result, additional value can be generated from the object by enabling the transfer of the object to the wireless device. Also, the object can be transferred to the predetermined web page without collaborating with the operator of the wireless device.

What is claimed is:

1. A method for transferring an object to a wireless device, the method comprising the steps of:
a. converting the format of the object to a wireless-device-format in response to a user input, the object being embedded in a predetermined web page, the wireless-device-format being a corresponding format supported by the wireless device; and
b. sending the object in the wireless-device-format to the wireless device.

2. The method of claim 1, wherein the format of the object is converted to a wireless-device-format at runtime.

3. The method of claim 1 further comprising the step of editing the object based on the user input.

4. The method of claim 3, wherein the step of editing comprises at least one of the steps of rotating the object, flipping the object, zooming-in the object, zooming-out the object, editing the duration of object and editing the frames of the object.

5. The method of claim 1, wherein the step of sending comprises the steps of:
a. receiving the transaction details from the user;
b. verifying the received transaction details; and
c. transmitting the object in the wireless-device-format to the wireless device in response to verification of the received transaction details.

6. The method of claim 5, wherein the transaction details comprises at least one of identification details of the wireless device, details of the wireless operator and credit card details of the user.

7. The method of claim 1, wherein the wireless device is a mobile phone.

8. The method of claim 1, wherein the wireless device is a Personal Digital Assistant (PDA).

9. A method for monetizing an object, the object being embedded on a predetermined web page, the method comprising the steps of:
a. linking the object to a server system;
b. sending a request to the server system to transfer the object in response to a user input; and
c. transferring the object to the wireless device in response to receiving the request, the object being transferred by the server system, wherein the step of transferring the object comprises the steps of:
i. converting the format of the object to a wireless-device-format in response to the request, the wireless-device-format being a corresponding format supported by the wireless device; and
ii. sending the object in the wireless-device-format to the wireless device.

10. The method of claim 9, wherein the format of the object is converted to a wireless-device-format at runtime.

11. The method of claim 9, wherein the step of linking the object to a server system comprises the steps of:
a. identifying automatically each object on the predetermined web page; and
b. tagging each object to the server system.

12. The method of claim 9 further comprising the step of editing the object based on the user input, the object being edited by the server system.

13. The method of claim 9, wherein the step of sending comprises the steps of:
a. receiving the transaction details from the user;
b. verifying the received transaction details; and
c. transmitting the object in the wireless-device-format to the wireless device in response to verification of the received transaction details.

14. The method of claim 9, wherein the transaction details comprises at least one of identification details of the wireless device, details of the wireless operator and credit card details of the user.

15. A server system for transferring an object to a wireless device, the server system comprising:
a. a format-conversion module, the format-conversion module converting the format of the object to a wireless-device-format in response to a user input, the object being embedded in a predetermined web page, the wireless-device-format being a corresponding format supported by the wireless device; and
b. an object-sending module, the object-sending module sending the object in the wireless-device-format to the wireless device.

16. The sever system of claim 15, wherein the format of the object is converted to a wireless-device-format at runtime.

17. The sever system of claim 15, wherein the object is linked to the server system.

18. The server system of claim 15 further comprising an editing module, the editing module editing the object based on the user input.

19. The server system of claim 15, wherein the object-sending module comprises:
a. a receiving module, the receiving module receiving the transaction details from the user;
b. a verification module, the verification module verifying the received transaction details; and
c. a transmitting module, the transmitting module transmitting the object in the wireless-device-format to the wireless device in response to verification of the received transaction details.

20. The server system of claim 15, wherein the object comprises at least one of an image, video, audio and text.

21. The server system of claim 15, wherein the format-conversion module and the object-sending module can be integrated into a single module.
